(19) United States
(12) Patent Application Publication
(10) Pub. No.: US 2011/0169773 A1
(43) Pub. Date: Jul. 14, 2011

(54) TOUCH KEYBOARD

(75) Inventor: TING LUO, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/761,356

(22) Filed: Apr. 15, 2010

(30) Foreign Application Priority Data
Jan. 14, 2010 (CN) 201010300299.4

(51) Int. Cl. G06F 3/042

(52) U.S. Cl. 345/175

(57) ABSTRACT

A touch keyboard includes a touch panel and a circuit board mounted in a housing. The touch panel includes a plurality of labeled touch portions reflecting an infrared ray when being touched. A plurality of infrared emitters and receivers are mounted on the circuit board each of which are corresponding to one of the touch portions. The infrared ray emitted by each infrared emitter is assigned with an identifier, the corresponding infrared receiver generates an electrical signal with the identifier. Each identifier corresponds to a touch portion. The processing unit mounted on the circuit board determines the identifier and the current intensity of the electrical signal. If the current intensity of the electrical signal is greater than or equal to a preset current intensity, the processing unit determines one of the touch portions is touched. As such, the processing unit further determines which of the touch portions is touched.

### BACKGROUND

1. Technical Field

The present disclosure relates to computer keyboards and, particularly, to a touch keyboard.

2. Description of the Related Art

Conventional computer keyboards operate by using a plurality of physical buttons. These buttons over use and time can dislodge or receive dust or dirt under the buttons making the buttons harder to be pressed, which may cause the users to feel tired after a long time using such keyboards.

### BRIEF DESCRIPTION OF THE DRAWINGS

The components in the drawings are not necessarily drawn to scale, the emphasis instead being placed upon clearly illustrating the principles of a touch keyboard. Moreover, in the drawings, like reference numerals designate corresponding parts throughout the several views.

FIG. 1 is an isometric view of a touch keyboard in accordance with an exemplary embodiment.

FIG. 2 is an exploded, perspective view of the touch keyboard of FIG. 1.

FIG. 3 is a cross-sectional view of the touch keyboard of FIG. 1.

### DETAILED DESCRIPTION

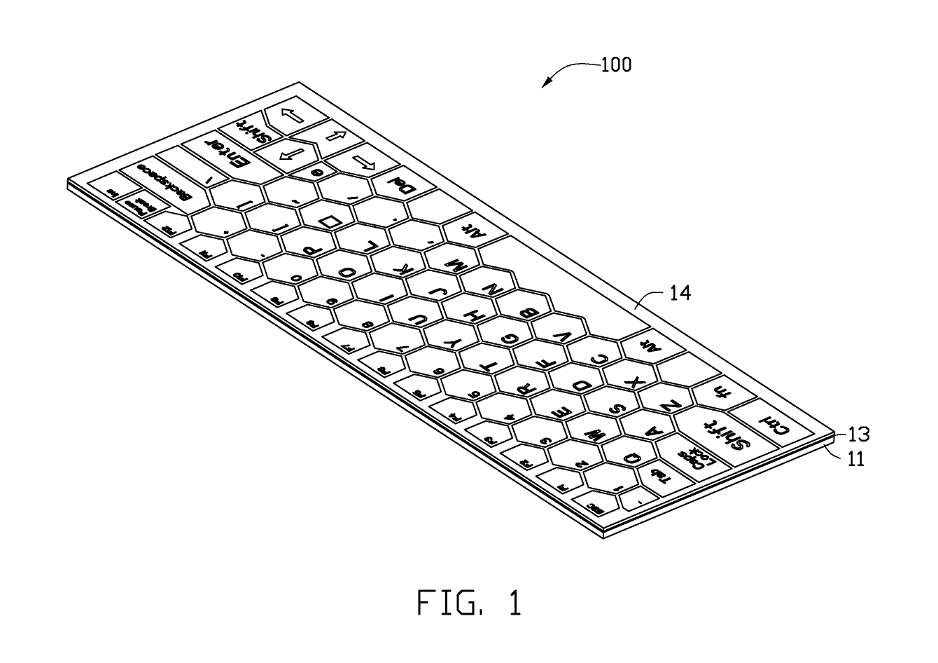

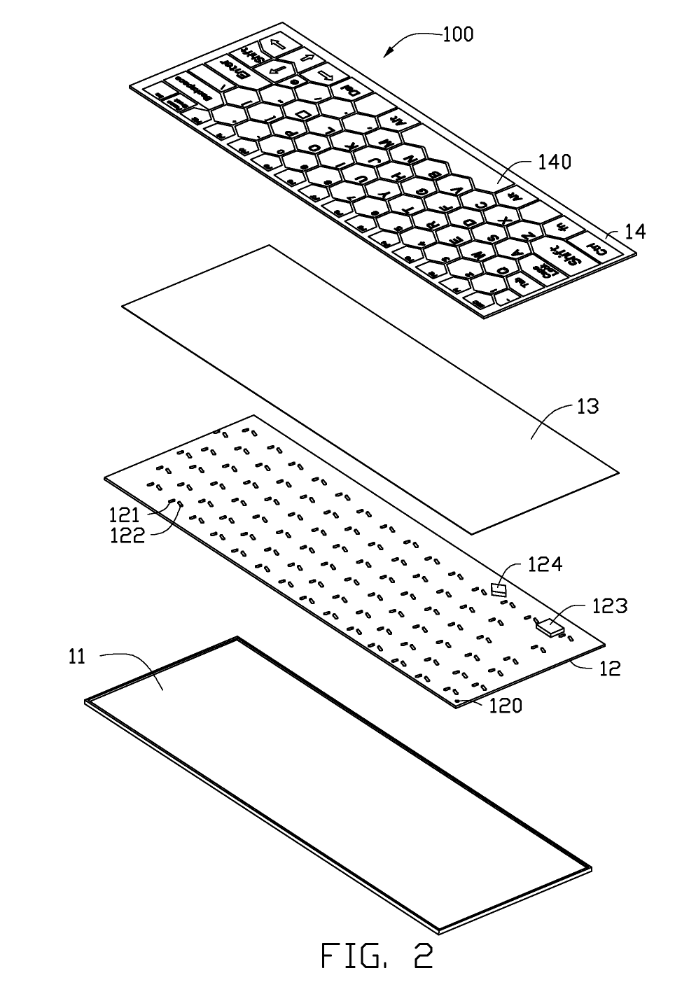

Referring to FIGS. 1-2, a touch keyboard 100 includes a housing 11 configured for receiving a circuit board 12 and a touch panel 14.

The touch panel 14 includes a plurality of labeled touch portions 140. In the exemplary embodiment, each of the touch portions 140 is transparent. In an alternative embodiment, each of the touch portions 140 defines a through hole. If one of the touch portions is not touched, an infrared ray can extend through the touch portions 140. If one of the touch portions 140 is touched, the touch portions 140 can reflect an infrared ray. In an exemplary embodiment, the touch panel 14 is made of acrylics.

A plurality of infrared emitters 121, a plurality of infrared receivers 122, a processing unit 123, and a storage unit 124 are mounted on the circuit board 12. Each of the infrared emitters 121 corresponds to one of the infrared receivers 122, and each pair of infrared emitters 121 and the corresponding infrared receiver 122 corresponds to one of the touch portions 140. In the embodiment, the infrared ray emitted by each of the infrared emitters 121 is assigned with an identifier. When one of the infrared receivers 122 receives an infrared ray, the infrared receiver 122 generates an electrical signal with one identifier, and transmits the electrical signal to the processing unit 123.

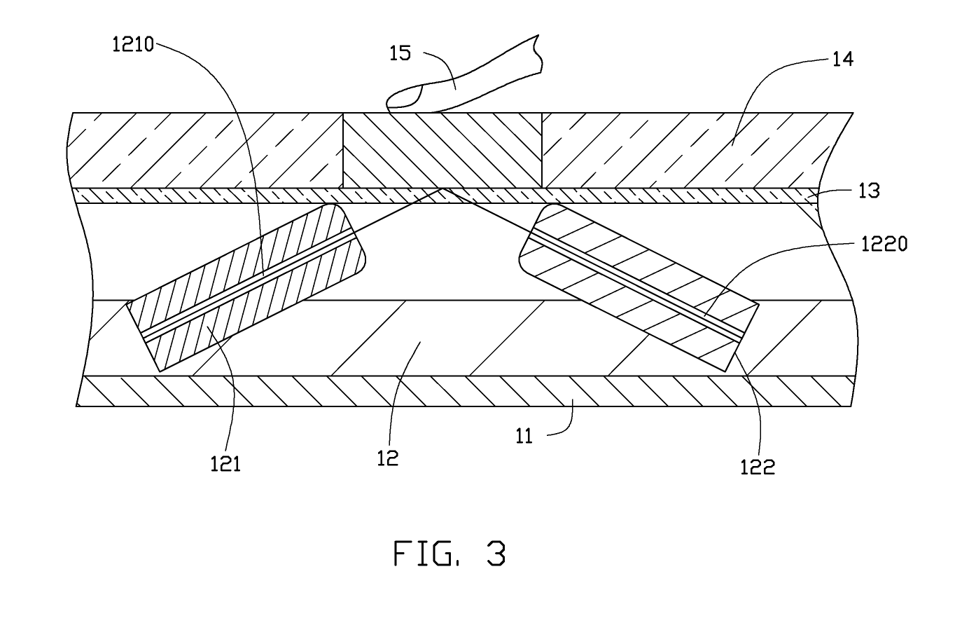

Referring also to FIG. 3, in the embodiment, each of the infrared emitters 121 includes a transmitting channel 1210, and each of the infrared receivers 122 includes a receiving channel 1220. The transmitting channels 1210 and the receiving channels 1220 are tubular. Each of the infrared emitters 121 emits an infrared ray via the transmitting channel 1210, and the infrared ray can be reflected by an opaque object 15 touched on the corresponding touch portion 140 and be received by the corresponding infrared receiver 122 via the receiving channel 1220. In the embodiment, the axis of each of the infrared receivers 122, the axis of the corresponding infrared emitter 121, and the transmitting path of the infrared ray reflected by the opaque object 15 touched on the corresponding touch portion 140 are on the same line. Therefore, each of the infrared receivers 122 can receive the infrared ray of the corresponding infrared emitter 121 reflected by an opaque object 15 touched on the corresponding touch portion 140. When the touch portion 140 is touched, the corresponding infrared receiver 122 can effectively produce an input.

The storage unit 124 stores an identifier-touch portion table and a preset current intensity. In the identifier-touch portion table, each of the identifiers corresponds to one touch portion 140. The preset current intensity is employed for determining whether one of the touch portions 140 is touched.

The processing unit 123 is configured for receiving and processing the electrical signal transmitted from the infrared receivers 122. The processing unit 123 obtains the identifier within the electrical signal and the current intensity of the electrical signal. If the current intensity of the electrical signal is greater than or equal to the preset current intensity, the processing unit 123 determines one of the touch portions 140 has been touched. If the processing unit 123 determines one of the touch portions 140 has been touched, the processing unit 123 further determines which one of the touch portions 140 has been touched according to the determined identifier and the identifier-touch portion table. If the current intensity is less than the preset current intensity, the processing unit 123 determines no touch portion 140 has been touched.

It should be noted that in the embodiment, if an opaque object 15 nears to the touch panel 14, the opaque object 15 may reflect an infrared ray to one of the infrared receivers 122. When receiving the infrared ray, the infrared receiver 122 generates an electrical signal, and the processing unit 123 determines the current intensity of the electrical signal. However, as the distance between the opaque object 15 and the infrared receiver 122 receiving the infrared ray is greater than the distance between the infrared receiver 122 and the touch portion 140 corresponding to the infrared receiver 122, the current intensity of the electrical signal is less than the preset current intensity. Therefore, when the opaque object 15 nears to the touch panel 14, even if one of the infrared receivers 122 receives the infrared ray, the processing unit 123 determines no touch portion 140 has been touched. Thus, erroneous operations can be avoided.

In the embodiment, a lighting element 120 is further mounted on the circuit board 12. The lighting element 120 is a light-emitting diode (LED). The housing 11 further receives a light-guiding panel 13. The light-guiding panel 13 is arranged between the circuit board 12 and the touch panel 14. The light-guiding panel 13 is configured for guiding the light emitted from the LED 120 to the touch panel 14. Therefore, the touch keyboard 100 can be operated in a dark environment.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch keyboard, comprising:
a housing;
a touch panel mounted in the housing, and comprising a plurality of labeled transparent touch portions, wherein if one of the touch portions is not touched, an infrared ray is able to extend through the one of the touch portions, if one of the touch portions is touched, the infrared ray is reflected;
a circuit board mounted below the touch panel;
a plurality of infrared emitters and a plurality of infrared receivers mounted on the circuit board, wherein each of the infrared emitters corresponds to one of the infrared receivers, and each pair of the infrared emitter and the corresponding infrared receiver corresponds to one of the touch portions, the infrared ray emitted by each of the infrared emitters is assigned with an identifier, when one of the infrared receivers receives the infrared ray, the one of the infrared receivers generates an electrical signal with the identifier;
a storage unit mounted on the circuit board and configured for storing an identifier-touch portion table and a preset current intensity, wherein in the identifier-touch portion table, each of the identifiers corresponds to one of the touch portions; and
a processing unit mounted on the circuit board and configured for receiving the electrical signal from each of the infrared receivers, wherein the processing unit determines the identifier and the current intensity of the electrical signal, if the current intensity of the electrical signal is greater than or equal to the preset current intensity, the processing unit determines one of the touch portions is touched, the processing unit further determines which of the touch portions is touched according to the determined identifier and the identifier-touch portion table.

2. The touch keyboard as recited in claim 1, wherein if the current intensity of the electrical signal is less than the preset current intensity, the processing unit determines no touch portion is touched.

3. The touch keyboard as recited in claim 1, wherein each of the infrared emitters comprises a transmitting channel therein, and each of the infrared receivers comprises a receiving channel therein, the axis of each of the infrared receivers, the axis of the corresponding infrared emitter, and the transmitting path of the infrared ray reflected by an opaque object on the corresponding touch portion are substantially on the same line when the corresponding touch portion is touched to effectively produce an input.

4. The touch keyboard as recited in claim 3, the transmitting channels and the receiving channels are tubular.

5. The touch keyboard as recited in claim 1, further comprising a lighting element mounted on the circuit board, and a light-guiding panel arranged between the circuit board and the touch panel, wherein the light-guiding panel is configured for leading the light emitted from the lighting element to the touch panel.

6. The touch keyboard as recited in claim 5, wherein the lighting element is an light-emitting diode (LED).

7. The touch keyboard as recited in claim 1, wherein the touch panel is made of acrylics.

8. A touch keyboard, comprising:
a touch panel comprising a plurality of touch portions, wherein if one of the touch portions is not touched, an infrared ray is able to extend through the one of the touch portions, if one of the touch portions is touched, the infrared ray is reflected;
a circuit board mounted below the touch panel;
a plurality of pairs of infrared emitter and infrared receiver mounted on the circuit board, wherein each pair of the infrared emitter and the corresponding infrared receiver corresponds to one of the touch portions, the infrared ray emitted by each infrared emitter is assigned with an identifier, the corresponding infrared receiver generates an electrical signal with the identifier according to the infrared ray;
a storage unit mounted on the circuit board and configured for storing an identifier-touch portion table and a preset current intensity, wherein in the identifier-touch portion table, each of the identifiers corresponds to one of the touch portions; and
a processing unit mounted on the circuit board and configured for receiving the electrical signal from each infrared receiver, obtaining the identifier and the current intensity of the electrical signal, and determining which of the touch portions is touched according to the identifier of the electrical signal and the identifier-touch portion table.

9. The touch keyboard as recited in claim 8, wherein if the current intensity of the electrical signal is greater than or equal to the preset current intensity, the processing unit determines one of the touch portions is touched, the processing unit further determines which of the touch portions is touched according to the determined identifier and the identifier-touch portion table;
if the current intensity of the electrical signal is less than the preset current intensity, the processing unit determines no touch portion is touched.

10. The touch keyboard as recited in claim 8, wherein each of the infrared emitters comprises a transmitting channel therein, and each of the infrared receivers comprises a receiving channel therein, the axis of each of the infrared receivers, the axis of the corresponding infrared emitter, and the transmitting path of the infrared ray reflected by an opaque object on the corresponding touch portion are substantially on the same line when the corresponding touch portion is touched to effectively produce an input.

11. The touch keyboard as recited in claim 10, the transmitting channels and the receiving channels are tubular.

12. The touch keyboard as recited in claim 8, further comprising a lighting element mounted on the circuit board, and a light-guiding panel arranged between the circuit board and the touch panel, wherein the light-guiding panel is configured for leading the light emitted from the lighting element to the touch panel.

13. The touch keyboard as recited in claim 12, wherein the lighting element is an light-emitting diode (LED).

14. The touch keyboard as recited in claim 8, wherein the touch panel is made of acrylics.
